(19) United States
(12) Patent Application Publication
(10) Pub. No.: US 2016/0208753 A1
(43) Pub. Date: Jul. 21, 2016

(54) FUEL INJECTION VALVE WITH CYLINDER INTERNAL PRESSURE SENSOR

(71) Applicant: KEIHIN CORPORATION, Tokyo (JP)

(72) Inventors: Gaku Sato, Utsunomiya-shi (JP); Kenichi Yoshimura, Sakura-shi (JP); Koji Suzuki, Utsunomiya-shi (JP); Keisuke Machida, Sakura-shi (JP)

(21) Appl. No.: 14/970,893

(22) Filed: Dec. 16, 2015

(30) Foreign Application Priority Data
Jan. 20, 2015 (JP) 2015-008430

(51) Int. Cl. F02M 57/00

(52) U.S. Cl. CPC F02M 57/005

(57) ABSTRACT

In a coupler unit of a resin mold portion that constitutes a fuel injection valve, power source terminals and a signal terminal, which are connected to an amplifying member, and a pair of drive terminals connected to a coil are disposed respectively in an exposed manner. Further, when the resin mold portion is molded from a resin material, in the interior of the coupler unit, a guide member is provided for positioning at predetermined locations the power source terminals, the signal terminal, and the drive terminals. With the guide member, by inserting the pair of power source terminals, the signal terminal, and the pair of drive terminals, respectively, through a plurality of first and second guide holes, the power source terminals, the signal terminal, and the drive terminals are positioned at locations separated mutually at predetermined intervals.

### CROSS-REFERENCE TO RELATED APPLICATION

This application is based upon and claims the benefit of priority from Japanese Patent Application No. 2015-008430 filed on Jan. 20, 2015, the contents of which are incorporated herein by reference.

### BACKGROUND OF THE INVENTION

1. Field of the Invention:

The present invention relates to a fuel injection valve equipped with a cylinder internal pressure sensor, the sensor being capable of detecting a cylinder internal pressure in the interior of a combustion chamber, the fuel injection valve being used in a direct injection type internal combustion engine in which fuel is injected directly into the combustion chamber in the internal combustion engine.

2. Description of the Related Art:

Heretofore, for example, as disclosed in Japanese Laid-Open Patent Publication No. 09-053483, with the aim of detecting a cylinder internal pressure of a combustion chamber in an internal combustion engine, it has been known to attach an internal pressure sensor to an end of a fuel injection valve. The internal pressure sensor is arranged between the end of the fuel injection valve and an attachment hole of a cylinder head that makes up the internal combustion engine. A lead line for transmitting to the exterior the detected cylinder internal pressure as an In addition, the lead line is connected, for example, to an electronic control unit, whereby a control or the like is performed based on the cylinder internal pressure by outputting the cylinder internal pressure as an output signal to the electronic control unit.

### SUMMARY OF THE INVENTION

However, with the above-described internal pressure sensor that is mounted on the fuel injection valve, the lead line, which is connected to the internal pressure sensor and the electronic control unit, is exposed to the exterior of the fuel injection valve. Therefore, in an assembled condition, or when the internal pressure sensor is attached to the cylinder head together with the fuel injection valve, there is a concern that a disconnection may occur as a result of loads that are applied with respect to the lead line, and that detection of the cylinder internal pressure cannot be performed due to such a disconnection.

Further, since the internal pressure sensor is arranged in contact with the cylinder head, it is easy for noise caused by vibrations or the like of the internal combustion engine to be generated, thus making it difficult to read out with high accuracy the detection value that is detected by the internal pressure sensor.

A general object of the present invention is to provide a fuel injection valve equipped with a cylinder internal pressure sensor, which can reliably carry out a connection with a signal transmitting member that transmits an output from the sensor, while in addition enabling an increase in detection accuracy.

The present invention is characterized by a fuel injection valve equipped with a cylinder internal pressure sensor, the fuel injection valve being configured to directly inject fuel into a combustion chamber of an internal combustion engine, the sensor being provided at an end of the fuel injection valve, the sensor being configured to detect a cylinder internal pressure in the interior of the combustion chamber, the fuel injection valve being operated by energization through drive terminals, the fuel injection valve including a signal transmitting member configured to transmit, as a detection signal, the cylinder internal pressure detected by the sensor. The signal transmitting member contains an amplifying circuit to which power source terminals are connected, the amplifying circuit being configured to amplify and output the detection signal, and a signal terminal configured to externally output the detection signal. The drive terminals, the power source terminals, and the signal terminal are accommodated in the interior of a coupler, and a guide member is provided in the coupler, the guide member being configured to position the drive terminals, the power source terminals, and the signal terminal.

According to the present invention, in the fuel injection valve equipped with the cylinder internal pressure sensor, the sensor being configured to detect a cylinder internal pressure in the interior of a combustion chamber, the signal terminal that outputs the detection signal detected by the sensor, and the amplifying circuit that amplifies the detection signal are disposed in the signal transmitting member, and the drive terminals, the power source terminals of the amplifying circuit, and the signal terminal are disposed in a state of being positioned mutually by the guide member in the interior of the coupler.

Consequently, in the interior of the coupler, since the plural terminals including the signal terminal, the power source terminals, and the drive terminals can be positioned and arranged at predetermined positions by the guide member, the power source terminals, the signal terminal, and the drive terminals can be connected reliably with respect to a connector that is connected to the coupler, and the detection signal can be output externally through the signal terminal. Further, even in the case that noise is generated due to vibrations or the like of the internal combustion engine, since it is possible for the detection signal in which noise is comparatively small to be amplified by the amplifying circuit at a position near to the sensor and be output, detection accuracy of the cylinder internal pressure by the sensor can be increased.

The above and other objects, features and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall front view, partially shown in cross section, of a fuel injection valve equipped with a cylinder internal pressure sensor according to an embodiment of the present invention;

FIG. 2 is an enlarged cross-sectional view showing the vicinity of a coupler in the fuel injection valve equipped with the cylinder internal pressure sensor of FIG. 1;

FIG. 3 is an external perspective view of a guide member that is incorporated in the coupler of FIG. 2;

FIG. 4A is a front view in the vicinity of the coupler of FIG. 2; and

FIG. 4B is a cross-sectional view taken along line IVB-IVB of FIG. 4A.

### DESCRIPTION OF THE PREFERRED EMBODIMENTS

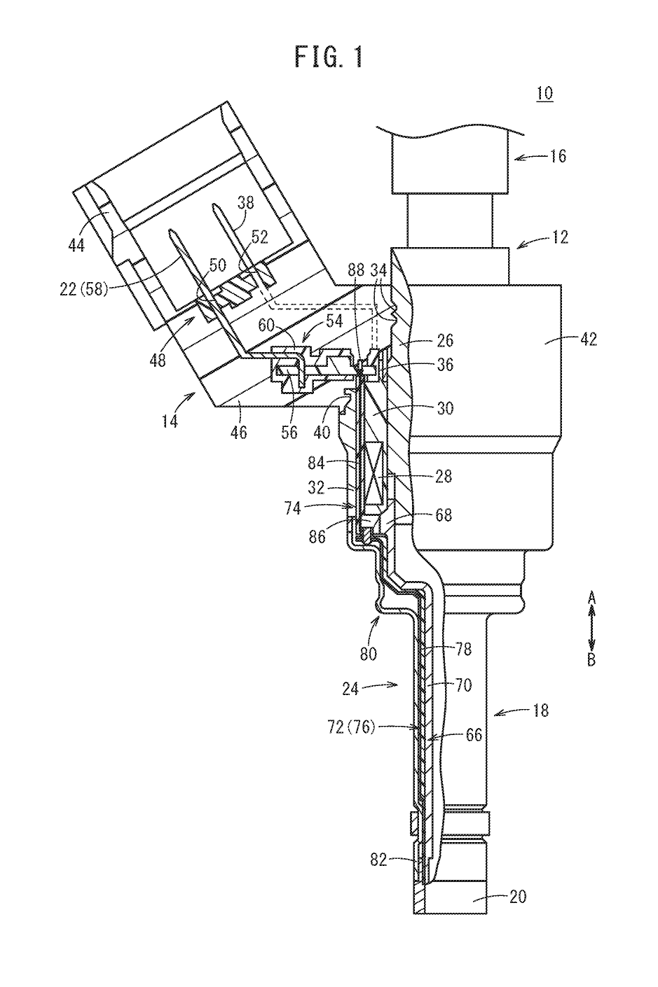

As shown in FIG. 1, a fuel injection valve 10 equipped with a cylinder internal, pressure sensor (hereinafter referred to simply as a fuel injection valve 10) includes a housing 12, a resin mold portion 14 provided on an outer circumferential side of the housing 12, a fuel supply unit 16 disposed on a proximal end of the housing 12 and to which fuel is supplied, a fuel injector 18 disposed on a distal end of the housing 12, a sensor 20 mounted on a distal end of the fuel injector 18, and a signal transmitting unit (signal transmitting member) 24 that electrically interconnects the sensor 20 and a signal terminal 22 connected to a non-illustrated electronic control unit (ECU) and thereby transmits detection signals therebetween.

Below, as shown in FIG. 1, the side of the fuel supply unit 16 in the fuel injection valve 10 will be referred to as a proximal end side (in the direction of the arrow A), and the side of the fuel injector 18 will be referred to as a distal end side (in the direction of the arrow B).

The housing 12, for example, is constituted as a solenoid unit that drives the fuel injection valve 10. The housing 12 includes a fixed core 26 that is disposed in the center thereof, a bobbin 30 that is provided on an outer circumferential side of the fixed core 26 and retains a coil 28, a cylindrical holder 32 disposed further on a distal end outer circumferential side of the bobbin 30, and a movable core (not shown) that is displaced under a magnetically excited action of the coil 28.

The fixed core 26 extends further to the proximal end side (in the direction of the arrow A) of the housing 12 with respect to the proximal end of the holder 32, and is arranged in the center of the later-described resin mold portion 14. Annular first grooves 34, which are engaged with the later described resin mold portion 14, are formed on the outer circumferential surface of the fixed core 26. Further, the fuel supply unit 16 is disposed on the proximal end side of the fixed core 26.

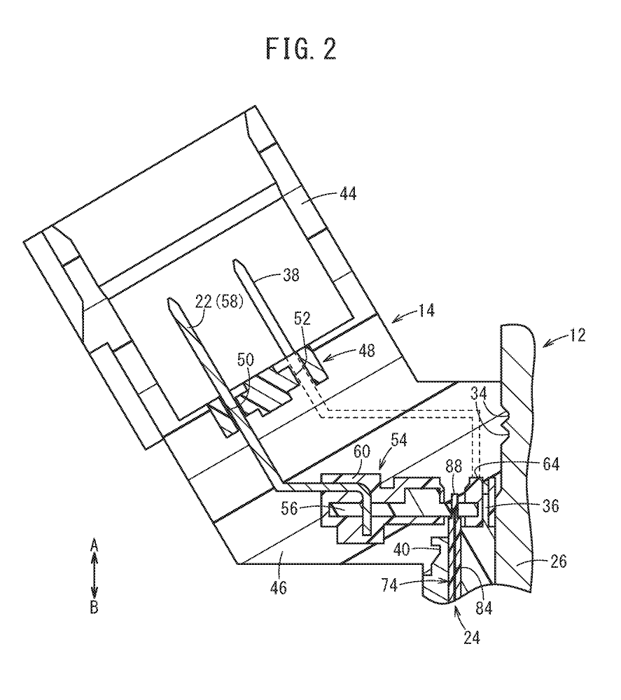

The bobbin 30 is formed in a cylindrical shape, for example, and is disposed between the fixed core 26 and the holder 32. An engagement pin 36 (see FIG. 2), which is engaged with another end of an amplifying member (amplifying circuit) 54, is formed on the proximal end side (in the direction of the arrow A) of the bobbin 30. Further, on an outer circumferential side of the bobbin 30, the coil 28 is wound in a radially inward recessed cavity, and a second signal transmitting member 74 that makes up the later-described signal transmitting unit 24 is disposed on the outer circumferential side of the coil 28.

Ends of the coil 28 extend to the proximal end side (in the direction of the arrow A) of the bobbin 30, and are connected respectively to ends of a pair of drive terminals 38, and by the coil 28 being supplied with electric current from a non-illustrated connector through the drive terminals 38, the coil 28 is excited and a magnetic force is generated. As a result, under a magnetic excitation action of the coil 28 in the housing 12, the movable core is displaced inside the bobbin 30, a valve element (not shown) disposed in the fuel injector 18 is attracted, and a valve open condition is brought about.

Further, on a proximal end outer circumferential surface of the holder 32, a radially inward recessed annular second groove 40 is formed, and the later-described resin mold portion 14 is engaged therein.

The resin mold portion 14, for example, is formed on the outer circumferential side of the housing 12 by being molded from a resin material. The resin mold portion 14 includes a main body section 42, which is formed in a cylindrical shape, a coupler unit (coupler) 44 that projects out sideways from the proximal end of the main body section 42, and a connector 46 that interconnects the main body section 42 and the coupler unit 44.

In addition, by the resin mold portion 14 being molded by the resin material, the molten resin material enters respectively into the first grooves 34 of the fixed core 26 disposed in the center of the main body section 42, and the second groove 40 of the holder 32 disposed on the distal end side of the main body section 42, and the housing 12 is fixed with respect to the center and the distal end of the resin mold portion 14.

As shown in FIGS. 1, 2, and 4A, the coupler unit 44 is formed, for example, with a rectangular shape in cross section, and projects in an obliquely upward direction, so as to be inclined at a predetermined angle with respect to the axial direction (the direction of arrows A and B) of the main body section 42. Further, an end of the coupler unit 44 is opened and includes a space in the interior thereof, with power source terminals 58 and a signal terminal 22 of the later-described amplifying member 54, and the pair of drive terminals 38 for energizing the coil 28 being provided in an outwardly exposed manner therein, respectively.

Further, in the interior of the coupler unit 44, a guide member 48 is provided for the purpose of mutually positioning the power source terminals 58, the signal terminal 22, and the drive terminals 38.

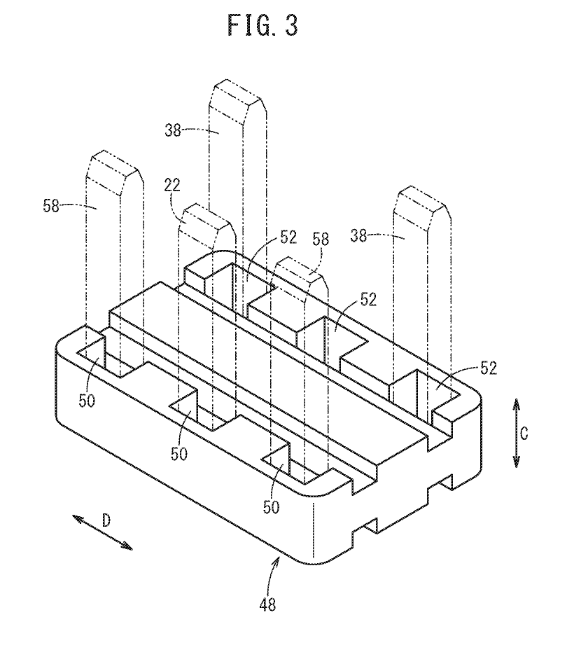

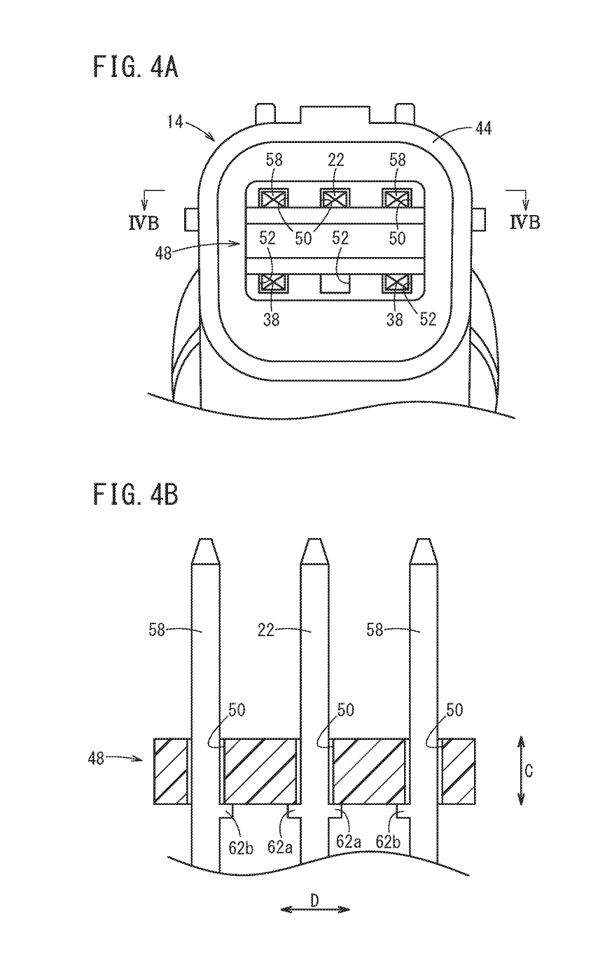

As shown in FIGS. 1 through 4B, the guide member 48 is constituted from a block body that is formed with a rectangular shape in cross section, for example, from a resin material. Plural first and second guide holes 50, 52 penetrate through the guide member 48 in the thickness direction thereof (the direction of the arrow C in FIG. 3). As shown in FIGS. 3 and 4B, the first and second guide holes 50, 52 are formed, for example, with a rectangular shape in cross section, are separated at equal intervals in a widthwise direction (the direction of the arrow D in FIG. 3) of the guide member 48, and are formed three each along straight lines in the widthwise direction. Further, the first guide holes 50 and the second guide holes 52 are formed substantially in parallel while being separated by a predetermined interval.

In addition, as shown in FIG. 2, the guide member 48 is disposed in the coupler unit 44 such that the ends thereof are substantially in parallel, and the first guide holes 50 are disposed on a lower side (in the direction of the arrow B), while the second guide holes 52 are disposed on an upper side (in the direction of the arrow A). The signal terminal 22 of the later-described amplifying member 54 is inserted through the central first guide hole 50, and the power source terminals 58 of the amplifying member 54 are inserted respectively through the first guide holes 50 of both ends (see FIGS. 3 and 4A).

On the other hand, with the second guide holes 52, by the drive terminals 38 being inserted respectively through the second guide holes 52 of both ends, a condition is brought about in which the power source terminals 58, the signal terminal 22, and the drive terminals 38 are positioned at predetermined locations and separated at predetermined intervals mutually from each other by means of the guide member 48. Note that, in this case, the central second guide hole 52 is not used.

As shown in FIGS. 1 and 2, the amplifying member 54, for example, is disposed in the interior of the resin mold portion 14. The amplifying member 54 includes a substrate 56 with a rectangular cross section, the power source terminals 58 and the signal terminal 22 that are connected electrically to the substrate 56, and a sealing member 60, which is formed so as to cover the entirety of the substrate 56. The amplifying member 54 is provided with the aim of amplifying a detection value (detection signal) detected by the sensor 20, and outputting the amplified detection value from the signal terminal 22 to external.

Concerning the power source terminals 58 and the signal terminal 22, as shown in FIG. 4A, for example, the signal terminal 22 is arranged substantially in the center in the transverse direction of the substrate 56, and the pair of power source terminals 58 are arranged on both sides of the signal terminal 22. In this state, one end of each of the power source terminals 58 and the signal terminal 22 is connected electrically with respect to the substrate 56 by solder or the like, and the power source terminals 58 and the signal terminal 22 extend at a predetermined angle of inclination with respect to an end portion of the substrate 56. More specifically, the two power source terminals 58 are arranged with respect to the substrate 56 so as to sandwich the signal terminal 22 between the pair of power source terminals 58.

Further, as shown in FIG. 4B, on the power source terminals 58 and the signal terminal 22, protrusions 62a, 62b are disposed at positions shifted by a predetermined length from the other ends that are exposed outwardly, toward the one ends thereof. The protrusions 62a, 62b project out substantially perpendicular to the direction of extension of the power source terminals 58 and the signal terminal 22. Moreover, the protrusions 62a, 62b are disposed substantially at the same positions in the direction of extension of the power source terminals 58 and the signal terminal 22.

In addition, when the power source terminals 58 and the signal terminal 22 are inserted through the guide member 48, the protrusions 62a, 62b come into abutment on the lower end surface of the guide member 48 to thereby lock the guide member 48. More specifically, the protrusions 62a, 62b function as positioning members for positioning the guide member 48 at a predetermined position with respect to the power source terminals 58 and the signal terminal 22.

The sealing member 60 is formed, for example, from a resin material. In a state in which the ends of the power source terminals 58 and the signal terminal 22 are connected with respect to the substrate 56, the sealing member 60 is formed so as to cover at a predetermined thickness the entirety of the substrate 56, and to cover the ends of the power source terminals 58 and the signal terminal 22 that are connected to the substrate 56. Consequently, the connection of the power source terminals 58 and the signal terminal 22 with respect to the substrate 56 is strongly maintained by the sealing member 60.

Further, in the sealing member 60, an engagement hole 64 is formed, which penetrates through the sealing member 60 in a thickness direction, on an end thereof on an opposite side from the end on the side of the power source terminals 58. The engagement pin 36 of the bobbin 30 that constitutes the housing 12 is capable of being inserted in the engagement hole 64 (see FIG. 2).

In addition, when the resin mold portion 14 is molded, by insertion of the engagement pin 36 of the bobbin 30 into the engagement hole 64 of the sealing member 60, the substrate 56 and the sealing member 60 are placed in a position corresponding to the connector 46, and the power source terminals 58 and the signal terminal 22 are placed in a position corresponding to the coupler unit 44. Then, in the above positional relationship, the amplifying member 54 is molded integrally with the resin mold portion 14. Further, at the same time, the second signal transmitting member 74 of the signal transmitting unit 24 is connected electrically with respect to the substrate 56.

At this time, the proximal end sides of the power source terminals 58 and the signal terminal 22 project out from the inner wall surface in the interior of the coupler unit 44, and the proximal end sides of the pair of drive terminals 38, which are positioned by the guide member 48, also project out from the inner wall surface in the interior of the coupler unit 44. The distal ends of the drive terminals 38 are connected to the coil 28.

Additionally, by connecting a non-illustrated connector to the coupler unit 44, electric power is supplied through the drive terminals 38 to the coil 28 of the housing 12, and the amplifying member 54 and the sensor 20 are energized through the power source terminals 58. Together therewith, the detection value detected by the sensor 20 is output externally as an electrical signal from the signal terminal 22 through the signal transmitting unit 24.

As shown in FIG. 1, the fuel supply unit 16, for example, includes a supply passage (not shown) through which fuel is supplied, in the interior of the fixed core 26, and a non-illustrated fuel pipe is connected to an end of the supply passage that opens on the proximal end side (in the direction of the arrow A) of the fuel injection valve 10. In addition, the fuel supplied through the fuel pipe passes through the supply passage, and is supplied to the side of the fuel injector 18 disposed on the distal end side (in the direction of the arrow B).

As shown in FIG. 1, the fuel injector 18 comprises a valve housing 66 that is connected to a distal end of the housing 12, and a valve element (not shown) that is incorporated in the distal end of the valve housing 66. In addition, fuel is supplied from the fuel supply unit 16 into the interior of the valve housing 66, and by the valve element being moved toward the proximal end side (in the direction of the arrow A) upon excitation of the coil 28, fuel is injected from the distal end into the combustion chamber at a predetermined pressure.

The valve housing 66, for example, is formed from a metallic material. The valve housing 66 includes a flange 68 that closes the distal end of the housing 12, and a tubular portion 70 that extends along a straight line to the distal end side (in the direction of the arrow B) from the flange 68. The cylindrical sensor 20 is press-inserted and fitted on an outer circumferential side on the distal end of the tubular portion 70.

The sensor 20, for example, is equipped with a piezoelectric element (not shown) in the interior thereof, and connection terminals, which are connected to the piezoelectric element, are exposed on the proximal end side (in the direction of the arrow A). Further, a retaining portion 82 of a later-described cover member 80 abuts on the outer circumferential surface of the sensor 20. In addition, a distal end inner circumferential side of the sensor 20, for example, is coupled by being welded around the entire circumference with respect to the valve housing 66.

The signal transmitting unit 24 includes a first signal transmitting member 72 disposed on the outer circumferential side of the valve housing 66 and connected to the sensor 20, and a second signal transmitting member 74 accommodated in the holder 32 of the housing 12, and which connects the first signal transmitting member 72 and the signal terminal 22.

The first signal transmitting member 72, for example, includes an insulating body 76 formed in a cylindrical shape from a resin material, and which is disposed on the outer circumferential side of the tubular portion 70 in the valve housing 66, and a first conductive layer 78 disposed in the interior of the insulating body 76. In addition, the first conductive layer 78 is electrically connected, for example by solder or the like, to a connection terminal of the sensor 20.

The insulating body 76 is formed from a resin material such as a heat resistant resin or the like, and is formed such that the proximal end side thereof (in the direction of the arrow A) is expanded in diameter corresponding to the shape of the valve housing 66 so as to cover the tubular portion 70 and the flange 68. The first conductive layer 78, which is made up from a plating layer, for example, is formed in the center in the thickness along a diametrical direction of the insulating body 76, and the first conductive layer 78 is formed in a cylindrical shape along the insulating body 76 at a substantially constant thickness. A distal end of the insulating body 76 is press inserted into the interior of the sensor 20 and around the tubular portion 70 of the valve housing 66.

On the other hand, on an outer circumferential side of the insulating body 76, a cover member 80, which is formed, for example, in a cylindrical shape from a metallic material, is mounted so as to cover the insulating body 76. The cover member 80 is formed such that the proximal end side thereof (in the direction of the arrow A) is expanded in diameter corresponding to the shape of the valve housing 66 so as to cover the tubular portion 70 and the flange 68. The retaining portion 82 that retains the outer circumferential surface of the proximal end side of the sensor 20 is formed on the distal end of the cover member 80.

The second signal transmitting member 74 is formed, for example, from a resin material, and is constituted in a plate shape having a predetermined length along the axial direction (the direction of arrows A and B), and a second conductive layer 84, which is formed from an electrically conductive material, is formed in the interior of the second signal transmitting member 74. The second conductive layer 84 is formed, for example, from a plating layer, which extends at a substantially constant thickness from the distal end to the proximal end along the axial direction (the direction of arrows A and B) of the second signal transmitting member 74.

A first connector 86, which projects in a perpendicular direction to the axial direction, is formed at the distal end of the second signal transmitting member 74. The first connector 86 is connected electrically by solder or the like with respect to the proximal end of the first signal transmitting member 72.

On the other hand, a small diameter second connector 88, which is reduced in diameter with respect to the distal end side, is included on the proximal end of the second signal transmitting member 74. A portion of the second conductive layer 84 is exposed in an annular shape on the second connector 88 along the outer circumferential surface thereof. In addition, by the second connector 88 being inserted into a connecting hole formed in the substrate 56 of the amplifying member 54 and electrically connected to the hole by solder or the like, the second signal transmitting member 74 is connected electrically with the amplifying member 54.

Consequently, a condition is brought about in which the signal terminal 22 is connected electrically and mutually with the sensor 20 through the first and second signal transmitting members 72, 74.

The fuel injection valve 10 equipped with a cylinder internal pressure sensor according to the embodiment of the present invention is constructed basically as described above. Next, a case in which the amplifying member 54 and the drive terminals 38 are molded in the interior of the resin mold portion 14 will be described.

At first, a condition is established in which an end of the amplifying member 54 is engaged with the proximal end of the bobbin 30 in the housing 12, and the second connector 88 of the second signal transmitting member 74 is connected to the substrate 56. As a result, the lower surface of the amplifying member 54 is retained under an engagement action with the engagement pin 36 and the second signal transmitting member 74, and the amplifying member 54 is maintained in a horizontal state substantially perpendicular to the axial direction (the direction of arrows A and B) of the fuel injection valve 10.

Next, from the distal end sides thereof, the power source terminals 58 and the signal terminal 22 are inserted through the guide member 48 via the first guide holes 50, together with the pair of drive terminals 38, which have been connected beforehand to the coil 28, being inserted through the second guide holes 52, and a condition is brought about in which the guide member 48 is retained by the power source terminals 58 and the signal terminal 22 through the protrusions 62a, 62b. In this manner, by insertion of the power source terminals 58, the signal terminal 22, and the drive terminals 38, respectively, through the first and second guide holes 50, 52 of the guide member 48, the respective terminals are maintained in a state of being positioned at predetermined locations and being separated mutually from each other at predetermined intervals.

The protrusions 62a, 62b are not limited to being disposed on the power source terminals 58 and the signal terminal 22 as described above. For example, similar protrusions may be provided on the side of the drive terminals 38, or may be provided on all of the power source terminals 58, the signal terminal 22, and the drive terminals 38. Stated otherwise, among the power source terminals 58, the signal terminal 22, and the drive terminals 38, the protrusions 62a, 62b may be provided on at least any one of them.

Lastly, the proximal end sides of the signal transmitting unit 24 and the bobbin 30 in the housing 12 are arranged in a forming mold (not shown) that is used for the purpose of molding the resin mold portion 14. Thereafter, by filling a molten resin material into a cavity interior of the forming mold, the main body section 42 of the resin mold portion 14 is formed in surrounding relation around the fixed core 26, and together therewith, the connector 46 and the coupler unit 44 are formed to extend radially outward from the main body section 42 so as to cover the amplifying member 54. Consequently, in the coupler unit 44, the guide member 48 is molded together with the power source terminals 58, the signal terminal 22, and the drive terminals 38, and is fixed in a state such that the distal ends of the terminals are exposed partially to the exterior.

Next, operations of the fuel injection valve 10, in which the resin mold portion 14 has been molded as discussed above, will be described.

In a non-illustrated internal combustion engine during driving, by a control signal from the electronic control unit, the coil 28 is energized from the drive terminals 38 of the fuel injection valve 10, so that the coil 28 is excited. Then, the valve element of the fuel injector 18 is placed in a valve open state, and high pressure fuel, which is supplied to the supply passage of the fuel supply unit 16, is injected directly into the combustion chamber of the internal combustion engine through the fuel injector 18. At this time, by a pressure (cylinder internal pressure) in the combustion chamber being applied, the piezoelectric element of the sensor 20 generates a voltage corresponding to the pressure, which is output as a detection signal.

The detection signal is output to the amplifying member 54 via the sensor 20, the first signal transmitting member 72, and the second signal transmitting member 74, and after the detection signal has been amplified in the amplifying member 54, the detection signal is output to the electronic control unit through the signal terminal 22.

In addition, for example, in the electronic control unit, the pressure of the combustion chamber is calculated from the amplified detection signal, and based on the calculated pressure, a combustion control or the like can be performed.

In the foregoing manner, according to the present embodiment, in the resin mold portion 14 that constitutes the fuel injection valve 10, the amplifying member 54 is provided, which is capable of amplifying and outputting the detection signals detected by the sensor 20. Together therewith, the guide member 48 is provided for positioning at predetermined locations the power source terminals 58 and the signal terminal 22 connected to the amplifying member 54, and the drive terminals 38 that supply electric current to the coil 28 of the housing 12.

Therefore, when the resin mold portion 14 is molded from a resin material, a condition is established in which the power source terminals 58, the signal terminal 22, and the drive terminals 38 are inserted respectively through the first and second guide holes 50, 52 of the guide member 48, whereby the plurality of terminals including the power source terminals 58, the signal terminal 22, and the drive terminals 38 are fixed with respect to the coupler unit 44 in a state of being accurately positioned at predetermined locations.

As a result, in the coupler unit 44, since relative shifting in position between the power source terminals 58, the signal terminal 22, and the drive terminals 38 can be avoided, and it is possible for a connector, which is connected to an electronic control unit, to be connected reliably with respect to the power source terminals 58, the signal terminal 22, and the drive terminals 38 in the coupler unit 44, detection signals from the sensor 20 can reliably be output to the electronic control unit through the signal terminal 22.

Further, since the detection signal output by the sensor 20 can be output from the signal terminal 22 after having been amplified suitably by the amplifying member 54, for example, even in the case that noise is generated due to vibrations or the like of the internal combustion engine, it is possible for the detection signal to be amplified at the interior of the fuel injection valve 10 which is situated near to the sensor 20 and for which noise is comparatively small, and as a result, the detection accuracy of the sensor 20 can be increased.

Furthermore, since the power source terminals 58 and the signal terminal 22 include the protrusions 62a, 62b which engage with and fix the guide member 48 when the terminals are inserted through the first guide holes 50, relative positioning of the guide member 48 with the power source terminals 58 and the signal terminal 22 can be carried out easily and reliably.

Stated otherwise, merely by inserting the power source terminals 58 and the signal terminal 22 of the amplifying member 54, which is positioned beforehand with respect to the housing 12 and the signal transmitting unit 24, through the first guide holes 50, the guide member 48 can be arranged at a predetermined position, and along therewith, the drive terminals 38 that are inserted through the second guide holes 52 can easily and reliably be positioned at predetermined locations.

Further still, the guide member 48, together with the power source terminals 58, the signal terminal 22, and the drive terminals 38, can be fixed reliably as a result of being molded in the interior of the resin mold portion 14.

The fuel injection valve equipped with a cylinder internal pressure sensor according to the present invention is not limited to the embodiment described above, and various additional or modified configurations may be adopted therein without departing from the scope of the present invention as set forth in the appended claims.

What is claimed is:

1. A fuel injection valve equipped with a cylinder internal pressure sensor, the fuel injection valve being configured to directly inject fuel into a combustion chamber of an internal combustion engine, the sensor being provided at an end of the fuel injection valve, the sensor being configured to detect a cylinder internal pressure in an interior of the combustion chamber, the fuel injection valve being operated by energization through drive terminals, the fuel injection valve comprising:
a signal transmitting member configured to transmit, as a detection signal, the cylinder internal pressure detected by the sensor;
wherein the signal transmitting member comprises:
an amplifying circuit to which power source terminals are connected, the amplifying circuit being configured to amplify and output the detection signal; and
a signal terminal configured to externally output the detection signal;
wherein the drive terminals, the power source terminals, and the signal terminal are accommodated in an interior of a coupler, and a guide member is provided in the coupler, the guide member being configured to position the drive terminals, the power source terminals, and the signal terminal.

2. The fuel injection valve equipped with the cylinder internal pressure sensor according to claim 1, wherein at least one of the drive terminals, the power source terminals, and the signal terminal comprises a positioning member configured to position the guide member.

3. The fuel injection valve equipped with the cylinder internal pressure sensor according to claim 1, wherein the coupler is molded from a resin material, and the guide member is sealed integrally in the interior of the coupler.
